(19) United States
(12) Patent Application Publication
(10) Pub. No.: US 2010/0071277 A1
(43) Pub. Date: Mar. 25, 2010

(54) METHOD FOR MANUFACTURING FLOOR PANELS, AS WELL AS FLOOR PANEL AND SEMI-FINISHED PRODUCT OBTAINED HEREWITH

(75) Inventor: Benny Schacht, Vlamertinge (BE)

Correspondence Address: Capitol City TechLaw, PLLC, PO BOX 1210, VIENNA, VA, 22183, US

(73) Assignee: FLOORING INDUSTRIES LIMITED, SARL, Bertrange (LU)

(21) Appl. No.: 12/529,321

(22) PCT Filed: Mar. 17, 2008
(86) PCT No.: PCT/IB2008/000629

§ 371 Date: Aug. 31, 2009

(30) Foreign Application Priority Data
Mar. 21, 2007 (BE) 2007/0141

(51) Int. Cl. E04C 2/24; B32B 37/14

(52) U.S. Cl. 52/173.1; 156/298

(57) ABSTRACT

Method for manufacturing floor panels of the type comprising at least a single-piece or multi-piece substrate (3) and a top layer (2) with a pattern (30), characterized in that photographic material (18) is present in the top layer (2) and that said pattern (30) is formed at least partially by performing a photographic process on said photographic material (18).

This invention relates to a method for manufacturing floor panels, more particularly laminate floor panels. It also relates to floor panels obtained with such method, and to semi-finished products which can be applied in such method.

In particular, the invention relates to a method for manufacturing floor panels of the type intended for forming a floating floor covering, wherein these floor panels comprise at least a single-piece or multi-piece substrate and a top layer with a pattern, wherein such pattern then preferably is obtained in an artificial manner.

It is known that with such floor panels, parquetry or other, whether or not wooden, floor parts are imitated. Herein, the imitation is realized at least by providing the floor panels with a decor representing a pattern of, for example, wood or wood parts.

From the prior art, a variety of possibilities are known by which said decor can be obtained. According to a first possibility, the decor is printed onto a material sheet, which then is provided on the substrate and forms, at least partially, the top layer of the final floor panel. Such method is known, for example, from GB 947,660. Usually, the obtained decor is covered with a wear-resistant layer, such as a transparent material sheet provided with resin, such as a so-called overlay, which is provided with hard wear-resistant particles, such as aluminum oxide. According to a second possibility, the decor, whether or not by the intermediary of a primer, is printed directly on the substrate. A method according to this second possibility is known, for example, from EP 1 419 902 or DE 103 14 738. Herein, analogous as well as digital printing techniques may be applied, and the obtained decor or pattern usually is covered with a wear-resistant lacquer. As an analogous printing technique, offset printing or screen printing may be used. As a digital printing technique, inkjet printing may be used.

In a method according to the first possibility, usually a supply of already printed paper with different patterns is kept, such that a market demand for a certain pattern can be satisfied in a smooth manner. Apart from a paper supply, such method may also rely on several buffer magazines of semi-finished products. With some types of floor panels, long cycle times may occur, and it may be necessary to apply resting times for the products, which makes the presence of such buffer magazines desirable.

In a method according to the second possibility, a supply of printed paper with different patterns is not necessary. However, buffer magazines in order to counterbalance resting times and the like are desirable, here, too. With this second possibility, problems may also arise in respect to the adjustment of the applied inks and/or the repeatability of such adjustment.

The aforementioned two possibilities, as well as all other known techniques for obtaining said decor relate to printing techniques. With such methods, a smooth switching of decor and/or pattern is difficult, cumbersome and/or expensive.

Generally, the present invention relates to an alternative method for the above-described possibilities of the prior art. In particular, the invention may also provide certain advantages in respect to the prior art. Thus, for example, it is possible that it can be applied more broadly and/or allows a more efficient manufacture and/or offers a solution for various problems occurring with the above-described possibilities of prior art methods.

To this aim, the invention relates to a method for manufacturing floor panels or other panels or plates of the type comprising at least a single-piece or multi-piece substrate and a top layer with a pattern, with the characteristic that photographic material is present in the top layer and that said pattern is formed at least partially by performing a photographic process on said photographic material. It is noted that it is not excluded that the pattern also is obtained partially according to any of the above-described possibilities of the prior art or according to still another, not above-described technique. Thus, with a wood pattern, it is, for example, possible that solely the wood pores are obtained by means of the photographic process, whereas the rest of the pattern is obtained, for example, by a print or coloration. Preferably, however, the entire pattern is formed by means of said photographic process, possibly with the exception of a uniform or substantially uniform background color.

It is clear that, although this is preferred, said top layer, or at least said photographic material, does not necessarily have to be located on said substrate when performing the photographic process. Thus, for example, it may be contemplated to form said portion of the pattern by means of the photographic process before applying the top layer on the substrate. In this latter case, the photographic process preferably is performed in line with the application of the top layer on the substrate.

According to the invention, the pattern is formed at least partially by a photographic process, which is performed directly on the top layer or the material of the top layer. Performing a photographic process on the top layer, or the material of the top layer, by which the pattern is formed at least partially, provides for that applying a print process for forming said pattern is excluded at least partially, and preferably entirely. In comparison to a print process, a photographic process offers better perspectives in respect to the automation thereof and/or limitation of the cycle time. A photographic process also offers a new range of possibilities when manufacturing floor panels. Moreover, such photographic process can be performed free of contact and requires less attention when adjusting the colors to be obtained.

Said photographic process relates to the agency of light to said photographic material. By light, here any form of electromagnetic radiation is intended. Preferably, however, the light will comprise wavelengths extending from ultraviolet over visible light to infrared, and still better the wavelengths will be restricted to wavelengths substantially situated in the visible light spectrum. In any case, thus, this preferably relates at least to light with wavelengths between 400 and 700 nanometers. It is clear that laser light may be applied, too, which then shows a limited wavelength spectrum. As a photographic process, for example and preferably, a process without a negative may be applied, such as a process of the type known under the denomination of “Daguerreotype”.

According to the present invention, by “photographic material” any material or any substance is intended which is light-sensitive. Preferably, this concerns silver-containing substances or substances containing silver compounds, such as silver salts. An example of such silver salt is silver halide. It is clear that, whether or not in combination with said materials, also other light-sensitive materials, such as photopolymers, may be applied.

In a preferred embodiment of the invention, the photographic material comprises at least three different light-sensitive substances, which each as such are sensitive to light in differing wavelength ranges. Herein, the differing wavelength ranges preferably are selected such that they allow, by the principle of color addition or color subtraction, to form a large variety of colors, and still better all or substantially all colors of visible light. Thus, for example, use can be made of substances which are selected such that one substance is at least sensitive to cyan-colored light, one substance is at least sensitive to magenta-colored light and one substance is at least sensitive to yellow-colored light. According to another example, use can be made of substances which are selected such that one substance is at least sensitive to red-colored light, one substance is at least sensitive to blue-colored light and one substance is at least sensitive to green-colored light.

The above examples of the respective preferred embodiment or other combinations of differing wavelength ranges preferably are combined with a black-colored layer situated beneath the effective photographic material, preferably such that a black color is present in the portion of the pattern formed by the photographic process at those places where during said photographic process no light incided onto the top layer.

When performing the photographic process of the invention, for example, use can be made of projection techniques, such as, for example, screening a slide, by which an image is formed on said photographic material. Other possible projection techniques are, for example, exposing said photographic material by means of a monitor, point-wise or line-wise projecting a beam of light, and constructing said image or the like by means of these projections. For the exposure of the photographic materials, apparatuses or principles known as such may be used, such as, for example, the exposure techniques known as such from the patent documents US 2002/135,857, US 2002/085,133, EP 1 746 823 and US 2006/066,92. The techniques presented in these patent documents relate to digital systems by which the photographic material can be exposed point-wise by means of a matrix of light points. In the first-mentioned documents, to this aim a so-called “light valve” is applied, which allows to individually control a large number of light points of a matrix. Such technology as such is already applied with flat-screens. In the last-mentioned document, to this aim an exposure head is used, which comprises a matrix of glass fiber ends, by which respectively a point on a photo-sensitive material can be exposed. Each glass fiber can transport the light generated by one or several LEDs. Such exposure head may be analogously applied for the exposure of photographic material as a printing head for printing on a substrate and it may move, in other words, relative in respect to the substrate to be exposed, or may be made sufficiently large, such that one or several of these exposure heads, even standing still in respect to the substrate, still can expose the entire of almost the entire width and/or length of the substrate.

The exposure times applied in the photographic process depend on the applied photographic material and/or the desired quality and may vary, for example, from 1 microsecond to several seconds.

In a preferred embodiment of the invention, said top layer comprises synthetic material in which said photographic material is integrated. The integration may be realized in many ways.

A first possibility consists in distributing or mixing said photographic material in said synthetic material. Preferably, the photographic material is homogenously spread in the synthetic material. According to another embodiment of this first possibility, the photographic material is concentrated in a zone of the top layer in which it then is homogenously spread. Thus, for example, the photographic material may be concentrated in a zone or layer extending only over a limited portion of the thickness of the top layer.

A second possibility consists in that said photographic material extends as a layer in said top layer and herein preferably, whether or not directly, is supported by a material sheet. According to this second possibility, it is also not excluded that several layers of photographic material are present in the top layer. In that case, they preferably extend layer-wise in this top layer, whereas they herein preferably are supported by a common material sheet. Herein, the material sheet may fulfill the function of said black-colored layer. It is noted that by “supporting” it is not necessarily meant that the respective material sheet is situated beneath the photographic material. It may also be situated above, in or among this photographic material. According to still another possibility, the supporting material sheet may comprise the photographic material concerned.

It is noted that the above-mentioned second possibility may also applied in a broader manner and in fact does not necessitate the presence of synthetic material in the top layer. In case, though, that synthetic material is used, it is possible to perform or not perform the photographic process or at least to expose or not expose the photographic material, before said synthetic material is provided on the photographic material.

The second possibility also allows building up the top layer, whether or not exclusively, from the photographic material, wherein this photographic material possibly may be supported by said material sheet. Such material sheet may be performed, for example, as a foil. Such foil then may be connected to the substrate, for example, by a glue connection, whether or not with the application of intermediate layers.

The above-mentioned second possibility also offers the option of combining the photographic material and the possible material sheet with other materials, such as with a lacquer entirely or wholly covering the formed pattern. As aforementioned, such lacquer may be used before as well as after performing said photographic process.

When the photographic material of the invention, in the final panel, is located beneath or in a synthetic layer, such as lacquer, such synthetic layer preferably is provided with substances which reduce or prevent the aging and/or disappearance of the photographically formed pattern. To this aim, the substances may be used which are known as such from photography, such as an absorbing material for ultraviolet light. For further examples of such substances, reference is made to GB 1 326 889.

It is noted that, by providing the photographic material on various discrete and/or on one or several wider continuous zones, distributed over the thickness of the top layer, patterns with a unique depth effect may be obtained. Such depth effects may be obtained by means of the above-mentioned first as well as by means of the above-mentioned second possibility. Possibly, transparent or translucent layers may be applied between said zones. These layers may also be colored or perform a certain optical effect, such as filtering or a polarization.

The photographic material which is applied in the invention preferably also comprises agents which contribute to the development and/or fixation of the pattern to be formed according to the invention.

In an important preferred embodiment of the present invention, said photographic material is formed at least by a photographic paper of the type used in instant cameras, and which is marketed, for example, under the trade name “Polaroid”. Such photographic material is known as such, for example, from the U.S. Pat. No. 2,543,181.

In general, the pattern formed according to the invention preferably is covered by a lacquer. This lacquer preferably has wear-resistant features, for example, in that hard particles, such as aluminum oxide, have been added. Thus, for example, UV-hardening or electron beam-hardening lacquers may be applied. Such lacquers are known as such from laminate panels which are provided with a pattern printed directly onto the substrate. To this end, reference is made, for example, to the international patent application WO 01/48333.

According to a variant, the pattern formed according to the invention may also be covered with a so-called overlay, which as such is known from said prior art. This overlay preferably consists of a transparent material sheet, which is provided with resin and which extends on top of said pattern. According to a particular embodiment of this variant, the so-called overlay is already present when performing said photographic process and/or said overlay comprises at least a portion of said photographic material.

According to another variant, it is possible that according to the invention, the pattern, whether or not already formed, is covered only with synthetic material, such as a resin, lacquer, varnish or the like, possibly with hard particles therein.

The method of the present invention further may comprise the steps of making the top layer, forming a plate comprising at least a portion of the top layer and the substrate, and forming the final floor panels from the obtained plate. In this case, said photographic process preferably is performed after said step of forming the plate. In general, it is desirable to perform the photographic process as close to the end of the manufacture of the floor panels as possible, in view of the fact that in this manner the possibility of limiting the number of buffer magazines or other stock locations can be utilized in an optimum manner. It is clear that this possibility is practically maximized when the photographic process of the invention is performed on the top layer of panels having approximately the dimensions of the final floor panels. These panels may be obtained by dividing said plate during said step of forming the final floor panels from the plate. It is clear that the invention is not restricted to performing the photographic process on the top layer of panels having approximately the dimensions of the final floor panels. Namely, it is also possible to begin earlier with exposing the photographic material, for example, before, in the present case, a photographic layer of synthetic material is provided.

According to the invention, it is possible that the top layer is made starting from a material sheet. This material sheet may relate to a paper sheet, or, according to a particular variant, may comprise photographic paper of the type available on the market under the denomination of Polaroid and/or is known as such, for example, from said U.S. Pat. No. 2,543,181.

Thus, in said step of making the top layer, it is possible that one or more sheets of photographic paper are provided with resin or other synthetic material, for example, are soaked in the resin. Herein, said plate preferably is formed by providing the top layer, or at least a portion thereof, on said substrate by means of a press treatment as a so-called “DPL” (Direct Pressure Laminate).

It is clear that the present invention also relates to a floor panel that is obtained or can be obtained by applying a method according to the invention.

Further, the invention also relates to a semi-finished product which can be realized during performing a method according to the present invention, with the characteristic comprises at least a single-piece or multi-piece substrate and a top layer, wherein photographic material is present in the top layer. Preferably, the photographic material relates to photographic paper of the type used in instant cameras. In an important preferred embodiment of the invention, the top layer of the semi-finished product does not yet comprise an individual pattern and/or comprises at most a pattern, color or coloration which is common to several of the final panels. From the above, it is clear that such semi-finished panels necessitate a minimum of stock, in view of the fact that they do not yet have an individual pattern. The semi-finished product may have any dimensions. Preferably, the semi-finished product has approximately the dimensions of the final floor panels.

With the intention of better showing the characteristics of the invention, hereafter, as an example without any limitative character, several preferred embodiments are described, with reference to the accompanying drawings, wherein:

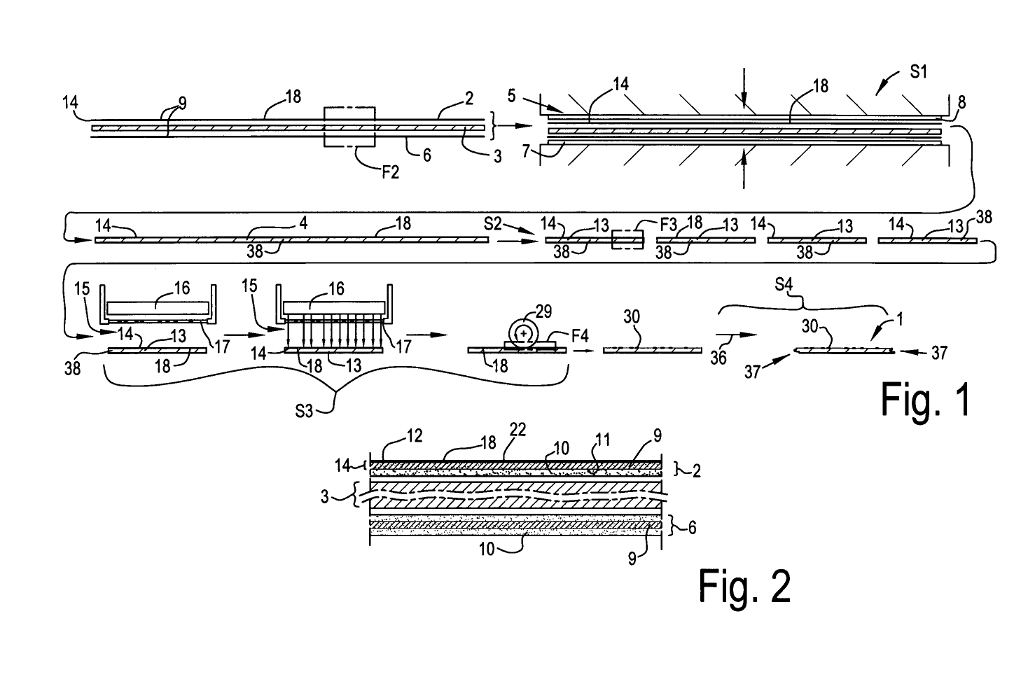

FIG. 1 schematically represents several steps in a method according to the invention;

FIGS. 2 to 4, at a larger scale, represent the areas indicated in FIG. 1 by F2, F3 and F4, respectively.

FIG. 1 illustrates a method for manufacturing floor panels 1, wherein, starting from a top layer 2 and a substrate 3, in a first step S1 a plate 4 is formed, preferably, as represented, by means of a DPL (Direct Pressure Laminate) process, wherein a press device 5 is used.

The top layer 2 and the substrate 3, as well as a backing layer 6 situated in this case at the underside of the substrate 3, are brought into the press device 5 and interconnected between a lower press element 7 and an upper press element 8, such as a press plate, under the influence of heat and pressure.

As represented in FIG. 2, use is made of a top layer 2 and a backing layer 6, which comprise a material sheet 9 which, in a preceding, not represented step is provided with resin 10 or other synthetic material. During the press treatment, the resin 10 cures and effects the connection with the substrate 3. Preferably, at least a quantity of resin 10 is provided at the underside 11 of the material sheet 9 of the top layer 2, such that at least a sufficient bond with the substrate 3 can be obtained. However, it is not excluded that a quantity of resin 10 is also provided at the upper side 12 of this material sheet 9 and/or that the respective resin 10 also penetrates into the material sheet 9.

According to the invention, substrate 3 and top layer 2 also may be interconnected in other manners. Thus, for example, the top layer 2, anyhow at least in case that it comprises a material sheet 9, simply may be glued on the substrate 3 as a foil with, for example, polyurethane or polyolefin glue. Of course, for example, when the top layer 2 does not comprise a material sheet 9, still other methods may be applied in order to bring together the substrate 3 and the top layer 2. Thus, for example, the material of the top layer 2 can be provided partially or entirely by means of a spraying, pouring or jetting technique and possibly hardened afterwards. Hardening may take place, for example, by means of a treatment with electron beams or ultraviolet rays.

In the method represented in FIG. 1, the plate 4, obtained by the press treatment, in a second step S2 is subdivided into panels 13, which in this case show approximately the dimensions of the final floor panels 1. According to the invention, such subdividing may be performed at any moment during the manufacture of the floor panels 1, either before performing the photographic process S3 or after performing the photographic process S3 or during performing the photographic process S3.

In general, it is noted that, independent from the applied photographic technique, it is preferred to perform the photographic process S3 on smaller panels 13 which are obtained by subdividing larger plates 4. Possibly, these smaller panels 13 may be subdivided or treated one or several times in a later treatment step, i.e. after or during the photographic process S3, until panels 13 are obtained showing substantially the dimensions of the final floor panels 1.

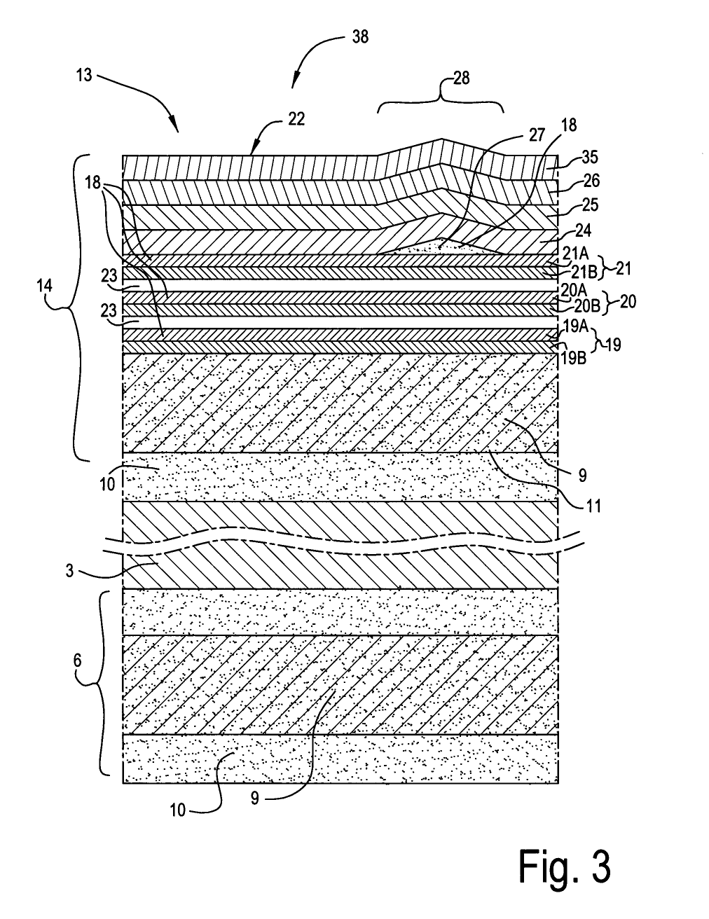

As becomes clear from FIG. 3, the boards or panels 13 of the example are provided with photographic paper 14 of the type that can be applied with instant cameras.

In FIG. 1 is represented that the boards or panels 13 provided with photographic paper 14 are brought in a treatment station 15 where said photographic process is performed in a third step S3. In the represented example, the panels 13, in a first partial step S31 of this third step S3, are exposed by shining through a slide 17 by means of a light source 16 and exposing the top layer 2 of the panels 13 to this light exposure. Other exposure methods and/or light sources, such as those mentioned in the introduction, may also be applied. In particular, the techniques are of interest wherein the exposure takes place digitally, for example, by exposing the panels 13 with a digitally built-up image and/or by exposing the panels 13 line-wise or point-wise. It is clear that possibly, a matrix of exposure points may be applied. Said digital image may be formed, for example, by a screen, such as a plasma screen, an LCD (Liquid Crystal Display) screen, a DLP (Digital Light Processing) screen or by means of LEDs (Light Emitting Diode). By building up a digital image in a line-wise or point-wise manner, use can be made, for example, of glass fiber cables to transport the light to the photographic material and possibly to focus it, such as it is the case when the technique, known as such, from the document US 2006/066,924 mentioned in the introduction is applied. Generally, it is noted that according to a non-represented variant, during the exposure during the photographic process, optical auxiliaries may be utilized at will, such as lenses, mirrors, camera lenses and the like.

FIG. 3 shows a possible construction of a panel 13 to be exposed. As aforementioned, the top layer 2 of the panel 13 according to the invention comprises photographic material 18. In this case, the photographic material is located in said photographic paper and as such extends as a layer in said top layer 2. Herein, the photographic material 18 is supported by said material sheet 9, which also forms part of said photographic paper 14. The photographic paper 14 applied here is of the type which can also be applied in instant cameras. Herein, the material sheet 9 preferably consists of a black or black-colored material, such as black plastic.

The photographic paper 14 represented here is characterized by its layered construction. On top of the material sheet 9, there are three color layers 19-20-21, which each as such respectively consist of a light-sensitive layer 19A-20A-21A and a development layer 19B-20B-21B preferably located there beneath. The material or the colorant of the development layer 19B-20B-21B is only operative when the respective pertaining light-sensitive layer 19A-20A-21A is not exposed to light. A development layer 19A-20A-21A of a certain color layer 19-20-21 respectively comprises a colorant of a certain color, which can couple to already exposed portions of the other color layers, more particularly of the light-sensitive layers of the other color layers.

Thus, for example, the color layers 19-20-21 in this case comprise a layer 19A which is sensitive to red light, with a development layer 19B with cyan colorant located there beneath, a layer 20A which is sensitive to green light, with a development layer 20B with magenta colorant located there beneath, and a layer 21A which is sensitive to blue light, with a development layer 21B with yellow colorant located there beneath, and such, preferably in the order of presence starting from the material sheet 9 in the direction of the surface 22 of the photographic paper 14, as shown here. In such a case, when the layer 20A which is sensitive to green light is exposed, the yellow and cyan colorant from the respective development layers 19B-21B will become active, whereas the magenta colorant in the respective development layer 20B, at least as far as the exposed zone is concerned, remains inactive. It is clear that the yellow colorant and the cyan colorant can combine to form a green color.

In the represented photographic paper 14, the color layers 19-20-21 are mutually separated by a separation layer 23.

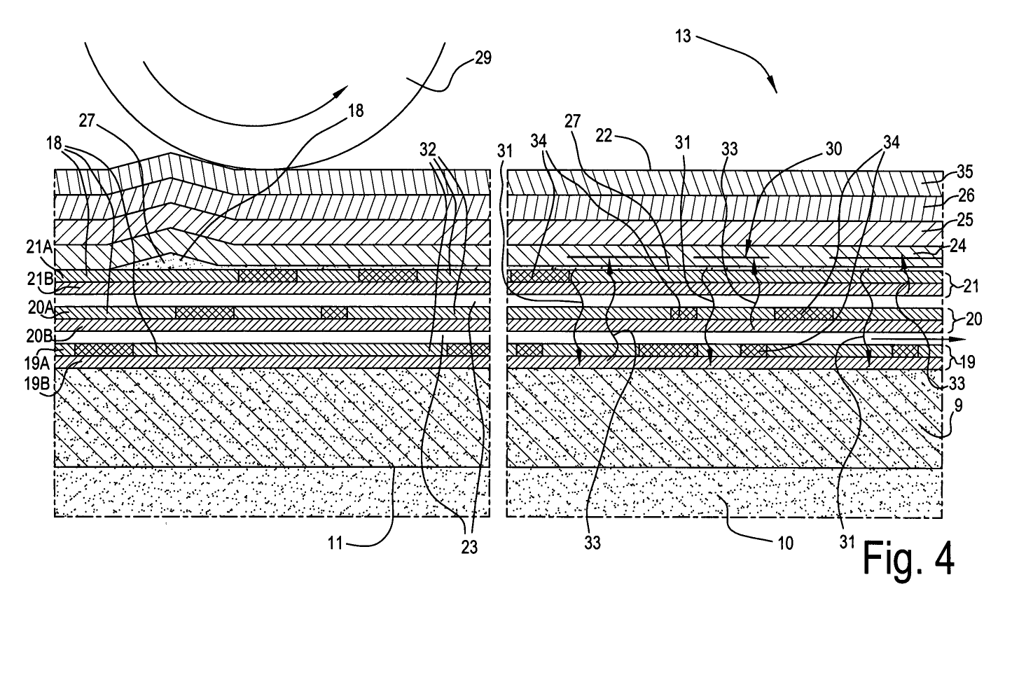

Apart from the separation layers 23 and color layers 19-20-21, which as such are built up from light-sensitive layers 19A-20A-21A and development layers 19B-20B-21B, the photographic paper 14 of the example also comprises one or more, and in this case three, layers 24-25-26, which initiate and/or support the development process. These initiating layers 24-25-26 preferably comprise all necessary chemicals for the development process. From the uppermost color layer 21 towards the surface 22 of the photographic paper 14, there are an image layer 24, a timing layer 26 and an acid layer 26. In between these initiating layers 24-25-26 and said color layers 19-20-21, there is a reagent 27 which can actuate the chemical development process. Initially, this reagent 27 is present in the photographic paper 14 only in restricted zones 28 and is distributed over the zones to be developed before the start of the development. This distribution, as schematically shown by the roll 29 in FIG. 1, may take place, for example, by spreading the respective reagent 27 by rolling it out in a second partial step S32 of said third step S3. The development process is shown in more detail in FIG. 4. The reagent 27 preferably comprises white pigment, opacifying agents (English: opacifiers), and/or alkalis, such as sodium hydroxide, sodium thiosulfate and potassium bromide. Preferably, said reagent comprises hydroquinone.

It is noted that such reagent 27 and/or such initiating layers do not necessarily have to be already present in the photographic paper 14. According to a variant, they may also be applied separately, whether or not in liquid form, before, during or after performing the exposure.

Further, it is noted that such reagent 27, certainly in the case when it is already comprised in the photographic paper 14, preferably is concentrated in so-called technical zones of the board or the panel 13. Such technical zones consist of the material that is removed when manufacturing the final floor panels 1. Thus, the pattern 30 formed or not formed in such zones is of no, little or solely of technical importance. In respect to this latter, for example, marks may be provided in the pattern of the technical zones, which marks may have a variety of useful applications. Thus, for example, they may be applied for a possible later subdividing of the boards or panels 13, or when providing a structure at the upper side of the boards or panels 13.

As shown in FIG. 4 by the arrows 31, the reagent 27 penetrates downward into all development layers 19B-20B-21B. Here, this reagent 27, or more particularly said alkalis, can activate the colorants located in the non-exposed portions 32 of the color layers 19-20-21. These activated colorants migrate, as indicated by the arrows 33, towards the image layer 24 in order to form a, preferably translucent, image or pattern 30. Thus, the image layer 24 in fact comprises the final pattern 30 formed according to the invention. Said white pigment of the reagent 27 is located in the photographic paper 14 beneath this image layer 24 and, in the case of a translucent image, can form a layer that reflects incident light on the photograph or the pattern 30 through the formed photographic image or pattern 30.

Said activation in the non-exposed portions 32, or rather the deactivation of the colorants in the exposed portions 34, may be performed, for example, as follows. The reagent 27 may transform the exposed portions 34 of the light-sensitive layers 19A-20A-21A into metallic silver, which in its turn immobilizes the colorant of the immediately respective underlying development layer 19B-20B-21B, for example, by forming a bond therewith. In the non-exposed portions 32 of the light-sensitive layers 19A-20A-21A, such transformation into metallic silver does not take place, and the colorants of the respective underlying development layer 19B-20B-21B remain free in order to diffuse to the image layer 24, where they possibly may merge with colorants of other development layers 19B-20B-21B.

During the development process, said opacifying agents provide for that after the actual exposure of said photographic process, no extra light incides upon the light-sensitive layers 19A-20A-21A.

Said acid layer 26 may decompose the opacifying agents of the reagent 27 and/or render them translucent or transparent, such that, preferably after the end of the development, an image or pattern 30 visible at the surface 22 of the photographic paper 14 will appear. The timing layer 25 may decelerate the penetration of said reagent 27, or at least of said opacifying agents, to the acid layer 26 located on top. In this manner, the image or pattern 30 has enough time to develop, without extra light inciding on the light-sensitive layers 19A-20A-21A. At the end of the development process, the layers 19A-20A-21A, which were light-sensitive beforehand, preferably are no longer light-sensitive.

In the example, said initiating layers 24-25-26 are protected by an extra layer 35 consisting, for example, of synthetic material. It may or may not be translucent or transparent and may or may not be removed in order to obtain the final panel 1. It is also possible to form a portion of the pattern 30 on this protective layer 35 by any technique, such as a printing technique.

In FIG. 1, by arrow 36 a fourth step S4 in the method according to the invention is indicated very schematically. By means of this fourth step S4, the finished final floor panel 1 is obtained. This step S4 may comprise a profiling treatment of one or more edges of the floor panel 1, for example, in order to form coupling means 37 of the type which can effect a horizontal and vertical locking among two of such floor panels 1. Such coupling means 37 are known as such, for example, from WO 97/47834. This fourth step S4 may also comprise applying a transparent or translucent additional protective layer on top of said pattern 30. Such protective layer may comprise a hardened substance, such as resin or lacquer, and may or may not comprise a material sheet, such as a paper sheet. Further, such protective layer may be provided with hard particles, such as aluminum oxide or other ceramic or mineral material. Namely, these particles may provide for a certain wear and/or scratch resistance of the surface of the final floor panel. Also during said fourth step S4, a structure may be formed at the surface of the floor panel 1 by means of impressions or recesses. Such structure is intended to emulate also the feel of the material imitated by means of the pattern. Thus, for example, in the case of a wood pattern, one may work with a structure emulating wood pores. Possibly, the obtained structure may correspond to the pattern 30 formed at least partially by means of the photographic process.

Referring to FIG. 1, it is clear that, amongst others, after performing said second step S2 of the method represented there, a semi-finished product 38 with the characteristics of the present invention is obtained. Preferably, such semi-finished product is already in a condition as close as possible to the finished product, with the exception of the fact that the portion of the pattern which is to be formed by the photographic process has not been formed yet. Thus, for example, it is not excluded that said coupling means 37 are already present at this semi-finished product and/or that said transparent or translucent additional protective layer is already provided.

Further, it is clear that said pattern 30 preferably relates to a wood pattern, wood parts pattern or stone pattern. However, it is not excluded that also other patterns, such as fantasy patterns, are applied.

Generally, it is noted that the present invention can also be applied more broadly than solely for manufacturing floor panels. Thus, it may also be used for manufacturing any panel provided with a pattern, such as, for example, for manufacturing furniture panels, wall panels, ceiling panels or other types of panels comprising at least a single-piece or multi-piece substrate and a top layer with a pattern. Therein, the particularity of the coated panels is characterized by the aforementioned characteristic of the invention or the preferred embodiments thereof.

According to deviating variants of the invention, in said photographic process also other forms of radiation than electromagnetic radiation may be applied. Thus, for example, particle radiation may be used. Of course, then as a photographic material, instead of a light-sensitive material a material is applied that is sensitive to the respective form of radiation.

The present invention is in no way limited to the embodiments described by way of example and represented in the figures, on the contrary may such methods, coated panels, such as floor panels, and semi-finished products, be realized according to various variants, without leaving the scope of the invention.

1. A method for manufacturing floor panels of the type comprising at least a single-piece or multi-piece substrate and a top layer with a pattern, wherein photographic material is present in the top layer and wherein said pattern is formed at least partially by performing a photographic process on said photographic material.

2. The method according to claim 1, further comprising:
making the top layer;
forming a plate including at least said top layer and said substrate; and
forming the floor panels from the plate.

3. The method according to claim 1, wherein said photographic process relates to the agency of light to said photographic material.

4. The method according to claim 1, wherein said photographic process comprises projecting an image onto said photographic material.

5. The method according to claim 1, wherein the top layer comprises synthetic material, in which said photographic material is integrated.

6. The method according to claim 1, wherein said photographic material extends as a layer in said top layer, and is supported by a material sheet.

7. The method according to claim 1, wherein said photographic material comprises at least three different light-sensitive substances, which each as such are sensitive to light in differing wavelength ranges.

8. The method according to claim 7, wherein said differing wavelength ranges are selected such that they allow to form all colors of visible light by means of addition or subtraction.

9. The method according to claim 8, wherein said differing wavelength ranges are selected such that one substance is at least sensitive to cyan-colored light, one substance is at least sensitive to magenta-colored light and one substance is at least sensitive to yellow-colored light.

10. The method according to claim 8, wherein said differing wavelength ranges are selected such that one substance is at least sensitive to red-colored light, one substance is at least sensitive to blue-colored light and one substance is at least sensitive to green-colored light.

11. The method according to claim 1, wherein said photographic material comprises agents that contribute to at least one of the development of said pattern and the fixation of said pattern.

12. The method according to claim 1, wherein said photographic material comprises silver compounds.

13. The method according to claim 2, wherein said photographic process is performed after forming the plate.

14. The method according to claim 13, wherein in said step of forming the floor panels from the plate, the plate is subdivided into panels having approximately the dimensions of the floor panels, and that said photographic process is performed on the top layer of the panels.

15. The method according to claim 1, wherein the pattern is covered with a lacquer.

16. The method according to claim 1, wherein said top layer comprises an overlay consisting of a transparent material sheet, which is soaked in resin and which extends on top of said pattern.

17. The method according to claim 1, wherein said photographic material consists of photographic paper of the type used in instant cameras.

18. The method according to claim 2, wherein in said step of making the top layer, the photographic paper is soaked in resin.

19. The method according to claim 18, wherein said plate is formed by providing said top layer on said substrate as a Direct Pressure Laminate.

20. A floor panel that is obtained by applying the method according to claim 1.

21. A semi-finished product for manufacturing a floor panel according to claim 1, wherein the semi-finished product comprises at least a single-piece or multi-piece substrate and a top layer, wherein photographic material is present in the top layer.

22. The semi-finished product according to claim 21, wherein said photographic material comprises photographic paper of the type used in instant cameras.
